(19) United States
(12) Patent Application Publication
(10) Pub. No.: US 2026/0004757 A1
(43) Pub. Date: Jan. 1, 2026

(54) MICROPHONE STAND AND MICROPHONE ASSEMBLY

(71) Applicant: GUANGDONG DINGCHUANG SMART MANUFACTURING CO., LTD., DONGGUAN (CN)

(72) Inventors: JUN LU, DONGGUAN (CN); LIANGMING WEN, DONGGUAN (CN); HONG ZHOU, DONGGUAN (CN)

(21) Appl. No.: 18/934,879

(22) Filed: Nov. 1, 2024

(30) Foreign Application Priority Data
Jun. 28, 2024 (CN) 202410861231.5

(51) Int. Cl. G10G 5/00

(52) U.S. Cl. CPC G10G 5/00

(57) ABSTRACT

A microphone stand includes an outer stand, an inner stand and an elastic lantern ring assembly. The outer stand includes a stand main body, the stand main body being provided with a mounting space. The inner stand arranged in the mounting space and connected with the stand main body. The inner stand being provided with an accommodating space for accommodating a microphone. The elastic lantern ring assembly connected between the inner stand and the outer stand. According to the microphone stand provided by the present disclosure, the inner stand and the outer stand are connected through the elastic lantern ring assembly, so that the microphone stand is connected stably, and a certain elastic space can also be formed between the inner stand and the outer stand. After the microphone is installed, the microphone can be supported stably, so that the shaking frequency of the microphone is reduced.

### CROSS-REFERENCE TO RELATED APPLICATIONS

The application claims priority of Chinese patent application CN202410861231.5, filed on Jun. 28, 2024, which is incorporated herein by reference in its entireties.

### TECHNICAL FIELD

The present disclosure relates to the technical field of microphone stand structures, in particular to a microphone stand and a microphone assembly.

### BACKGROUND

With the development of microphone technology, microphones are increasingly and widely used in various industries. The microphone usually needs to be fixed when in use, so that the hands of a user can be liberated.

The existing microphone stand is wound and mounted through a lanyard to connect the inner stand and the outer stand of the microphone, so that the effects of supporting and stabilizing the microphone are achieved. In such connection mode, the inner stand and the outer stand need to be wound and mounted many times by a lanyard, so that the microphone stand is complex in operation and inconvenient to use.

### SUMMARY

In a first aspect, the present application provides a microphone stand. The microphone stand, includes:
an outer stand, includes a stand main body, the stand main body being provided with a mounting space;
an inner stand, arranged in the mounting space and connected with the stand main body, and the inner stand being provided with an accommodating space for accommodating a microphone; and
an elastic lantern ring assembly, connected between the inner stand and the outer stand.

Compared with the prior art, according to the microphone stand provided by the present disclosure, the inner stand and the outer stand are connected through the elastic lantern ring assembly, so that the microphone stand is connected stably, and a certain elastic space can also be formed between the inner stand and the outer stand. After the microphone is installed, the microphone can be supported stably, so that the shaking frequency of the microphone is reduced. When sound waves sent out by a sound source are received by the microphone, the sound waves can act on each component of the microphone and also can act on the microphone stand, so that the microphone and the microphone stand produce unnecessary mechanical vibration to result in increase of ground noise of the microphone. The inner stand and the outer stand are connected through the elastic lantern ring assembly, so that the influence of mechanical vibration on the sound receiving aspect of the microphone can be reduced to achieve a cushioning effect. Wherein, the ground noise refers to noise generated by the system or equipment without signal input. At the same time, the microphone stand provided by the present disclosure can also avoid large shaking of the microphone, so that the effect of protecting the microphone is achieved to prevent the damage of the internal structure.

In an embodiment, the stand main body is provided with two end faces arranged oppositely, and an inner surface and an outer surface which are connected to the two end faces, the outer stand also includes a connecting structure arranged on the inner surface, and the lantern ring assembly sleeves the connecting structure.

The connecting structure is arranged on the inner surface of the outer stand. Through sleeve connection of the lantern ring assembly, the connection of the inner stand and the outer stand is facilitated to realize rapid installation and disassembly, and the operation is simple, so that the production assembly efficiency is improved.

In an embodiment, the connecting structure includes a connecting piece, the connecting piece includes a connecting part and a first fixed part connected with the connecting part; the connecting part is connected to the inner surface of the outer stand; and the lantern ring assembly sleeves the first fixed part.

The lantern ring assembly sleeves the first fixed part, so that the installation and disassembly between the lantern ring assembly and the first fixed part are more convenient, and the operation is simple.

In an embodiment, the connecting structure also includes a connecting block, the connecting block is connected to the connecting part and the inner surface of the outer stand.

The connecting block is connected to the connecting part and the outer stand, and the connection is more stable, so that a certain gap is formed between the connecting piece and the inner surface of the outer stand, and the sleeving of the lantern ring assembly is facilitated.

In an embodiment, the connecting piece also includes a second fixed part connected with the connecting part, and the first fixed part and the second fixed part are respectively arranged at both ends of the connecting part; and the lantern ring assembly sleeves the first fixed part and the second fixed part.

The second fixed part is arranged, the lantern ring assembly sleeves the first fixed part and the second fixed part to ensure the stability of the sleeve connection of the lantern ring assembly.

In an embodiment, the lantern ring assembly includes a main body part, and a first lantern ring and a second lantern ring which are connected with the main body part, the first lantern ring sleeves the first fixed part, the second lantern ring sleeves the second fixed part, and the main body part is connected with the inner stand.

The first lantern ring and the second lantern ring respectively sleeve the first fixed part and the second fixed part, so that the connection can be more stable, and the assembly and production are facilitated

In an embodiment, the lantern ring assembly and the inner stand are integrally formed.

By adopting the integral molding process, the connection between the lantern ring assembly and the inner stand can be more stable.

In an embodiment, the microphone stand also includes a locking assembly configured to be adjustable relative to the inner stand, the locking assembly penetrates penetrate through the inner stand, and the locking assembly is used for abutting against one end of the microphone to extend to the accommodating space.

The locking assembly is arranged to abut against the microphone, so that the microphone can be better fixed. And the tightness of the microphone mounted on the microphone stand can be adjusted, so that the installation and disassembly of the microphone are more convenient.

In an embodiment, a mounting hole which penetrates through the inner stand and communicates with the accommodating space is formed in the inner stand; and the locking assembly includes a fixing piece, the fixing piece penetrates through the mounting hole and is configured to be movable along the axial direction inside the mounting hole.

The fixing piece is arranged to move axially inside the mounting hole, so that the microphone is locked or loosened, the structure is simple, and the cost is low.

In an embodiment, the mounting hole and the fixed part are provided with matched screw threads, so that the fixing piece is in threaded connection to the mounting hole.

The connection between the fixing piece and the microphone and the movement of the fixing piece are realized through screw connection, the structure is simple and practical, and the stability is high.

In an embodiment, the locking assembly also includes a cushion pad for abutting against the microphone, and the cushion pad is arranged at one end, located in the accommodating space, of the fixing piece.

The cushion pad is arranged, so that the fixing piece can be avoided from scratching the microphone to play a protective role. The cushion pad can also play a cushioning role, the acting force and noise of mechanical vibration are absorbed, and shaking is avoided to cause damage to the internal components of the microphone, so that the performance of the microphone is ensured. In an embodiment, the cushion pad is of elasticity, and the cushion pad is configured to be deformable.

By adopting the elastic cushion pad with deformability, the shaking of the microphone caused by shaking or vibration can be avoided, and scratching of the microphone or damage to the internal parts of the microphone are avoided.

In an embodiment, the cushion pad is made of silica gel, and the cushion pad is of a hemispherical structure.

The hemispherical structure design can better abut against the microphone and connect the fixing piece, so that the microphone is protected.

In an embodiment, the inner stand includes a first stand and a second stand connected with the first stand, the first stand is arranged between the second stand and the outer stand, the first stand is connected with the outer stand, and the second stand is enclosed to form the accommodating space.

The first stand and the second stand are respectively connected to the outer stand and the microphone, so that the connection stability can be improved, and the influence of shaking or vibration on the microphone can be reduced. In an embodiment, a gap is formed between the first stand and the second stand, a connecting rack is arranged between the first stand and the second stand, and the first stand and the second stand are connected through the connecting rack.

The gap is arranged, which further reduce the impact of vibration and play a buffering role.

In an embodiment, the microphone stand also includes a mounting rack, and the mounting rack is configured to be rotatably connected with the outer stand.

The outer stand can rotate relative to the mounting rack by arranging the mounting rack, and the angle is convenient for the user to adjust, so that the microphone is convenient for the user to use.

In an embodiment, the outer stand also includes a rotating part connected with the stand main body, an axle hole is formed in the rotating part, the mounting rack includes a rotating shaft penetrating through the axle hole and a connecting rod, and one end of the connecting rod is connected with the rotating shaft.

In another aspect, the present disclosure further provides a microphone assembly, includes a microphone and a microphone stand, wherein a groove or a clamping hole is formed in the microphone, or a groove and a clamping hole are formed in the microphone;
the microphone stand includes:
an outer stand, includes a stand main body, the stand main body being provided with a mounting space;
an inner stand, arranged in the mounting space and connected with the stand main body, and the inner stand being provided with an accommodating space for accommodating a microphone;
a lantern ring assembly, connected to the inner stand and the outer stand, the lantern ring assembly being of elasticity; and
a locking assembly, configured to be movable relative to the inner stand, the locking assembly penetrating through the inner stand, one end of the locking assembly extending to the accommodating space and being configured to abut against the groove or the clamping hole.

According to the microphone assembly provided by the present disclosure, the groove is formed in the microphone, and the locking assembly is arranged on the microphone stand to abut against the groove or the clamping hole, so that the microphone can be installed on the microphone stand more stably.

In an embodiment, a groove and a clamping hole are formed in the microphone, the microphone is surrounded by the groove annularly, the number of the clamping holes is two or more than two, and the clamping holes are formed in the groove at intervals.

The stability for fixing the microphone can be improved by arranging the clamping hole. It is possible to ensure the stability of the microphone during rotating by arranging the groove, so that the axial movement of the microphone is avoided.

In an embodiment, the locking assembly includes a fixing piece penetrating through the inner stand to abut against the microphone and a cushion pad for abutting against the microphone. The maximum diameter of the cushion pad is larger than the notch diameter of the groove, or the maximum diameter of the cushion pad is larger than the maximum pore diameter of the clamping hole. In this way, it is possible to ensure that the cushion pad is partially located in the clamping hole or the groove and partially located outside the groove or the clamping hole, so that the cushion pad is ensured to tightly abut against the groove or the clamping hole, the mechanical collision between the cushion pad and the microphone stand is reduced, and the ground noise of the microphone is reduced.

Compared with the prior art, according to the microphone stand provided by the present disclosure, the inner stand and the outer stand are connected through the elastic lantern ring assembly, so that the microphone stand is connected stably, and a certain elastic space can also be formed between the inner stand and the outer stand. After the microphone is installed, the microphone can be supported stably, so that the shaking frequency of the microphone is reduced. When sound waves sent out by a sound source are received by the microphone, the sound waves can act on each component of the microphone and also can act on the microphone stand, so that the microphone and the microphone stand produce unnecessary mechanical vibration to result in increase of ground noise of the microphone. The inner stand and the outer stand are connected through the elastic lantern ring assembly, so that the influence of mechanical vibration on the sound receiving aspect of the microphone can be reduced to achieve a cushioning effect. Wherein, the ground noise refers to noise generated by the system or equipment without signal input. At the same time, the microphone stand provided by the present disclosure can also avoid large shaking of the microphone, so that the effect of protecting the microphone is achieved to prevent the damage of the internal structure.

### BRIEF DESCRIPTION OF THE DRAWINGS

In order to explain the technical solutions of the embodiments of the present disclosure more clearly, the following will briefly introduce the accompanying drawings used in the embodiments. Apparently, the drawings in the following description are only some embodiments of the present disclosure. Those of ordinary skill in the art can obtain other drawings based on these drawings without creative work.

FIG. 1 is a space diagram of a microphone stand provided by the embodiment of the present disclosure.

FIG. 2 is a space diagram of a microphone stand from another angle provided by the embodiment of the present disclosure.

FIG. 3 is a space diagram of a microphone stand provided with a microphone when in use provided by the embodiment of the present disclosure.

FIG. 4 is a breakdown schematic diagram of a microphone stand provided by the embodiment of the present disclosure.

FIG. 5 is a breakdown schematic diagram of a microphone stand from another angle provided by the embodiment of the present disclosure.

FIG. 6A is a schematic diagram of a connecting structure of a microphone stand provided by the embodiment of the present disclosure.

FIG. 6B is a structural schematic diagram of a connecting structure of a microphone stand provided by a deformable embodiment of the present disclosure.

FIG. 6C is a schematic diagram of a connecting structure of a microphone stand provided by another deformable embodiment of the present disclosure.

FIG. 6D is a schematic diagram of a connecting structure of a microphone stand provided by yet another deformable embodiment of the present disclosure.

FIG. 6E is a schematic diagram of a connecting structure of a microphone stand provided by yet another deformable embodiment of the present disclosure.

FIG. 7 is a schematic diagram of a lantern ring assembly of a microphone stand as shown in FIG. 1.

FIG. 8 is a schematic diagram of a cooperative relationship of the lantern ring assembly and a connecting structure of a microphone stand as shown in FIG. 1.

FIG. 9 is a schematic diagram of a locking assembly of a microphone stand as shown in FIG. 1.

FIG. 10A is a schematic diagram of a microphone provided by the embodiment of the present disclosure.

FIG. 10B is a structural schematic diagram of a microphone provided by a deformable embodiment of the present disclosure.

FIG. 10C is a structural schematic diagram of a microphone provided by another deformable embodiment of the present disclosure.

### DETAILED DESCRIPTION OF THE EMBODIMENTS

In order to facilitate understanding the present disclosure, the present disclosure will be described more comprehensively below with reference to related accompanying drawings. Preferred implementations of the present disclosure are provided in the drawings. However, the present disclosure can be implemented in many different forms, and are not limited to the implementations described herein. On the contrary, these implementations are provided to make the content disclosed in the present disclosure understood more thoroughly and comprehensively.

It should be noted that when an element is referred to as being “fixed to” another element, the element can be directly on another component or there can be a centered element. When an element is considered to be “connected” to another element, the element can be directly connected to another element or there may be a centered element. The terms “inner”, “outer”, “left”, “right”, and similar expressions used herein are for illustrative purposes only and do not necessarily represent the only implementation.

Unless otherwise defined, all technical and scientific terms used herein have the same meaning as those commonly understood by a person skilled in the art to which the present disclosure belongs. Terms used in the specification of the present disclosure herein are merely intended to describe objectives of the specific embodiments, but are not intended to limit the present disclosure. The term “and/or” used herein includes any and all combinations of one or more related listed items.

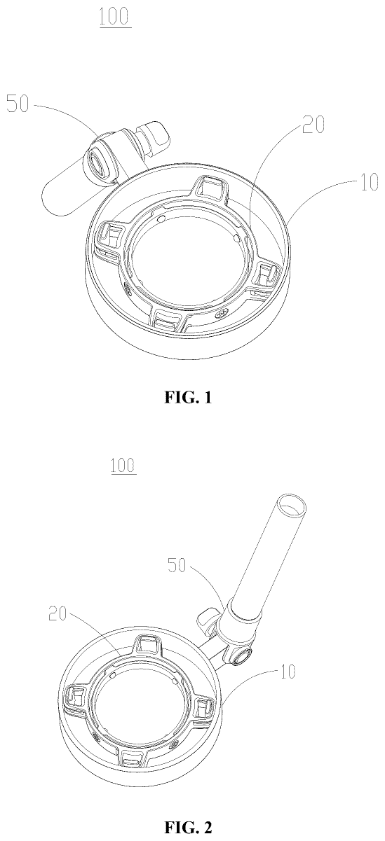

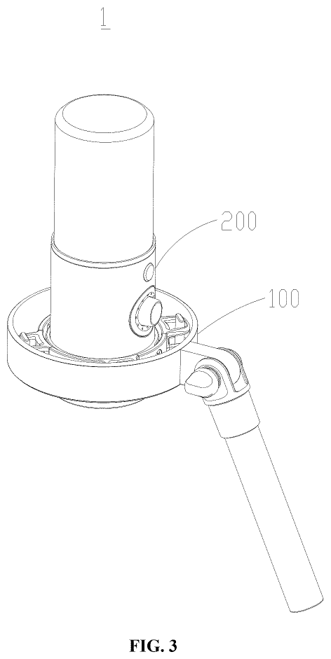

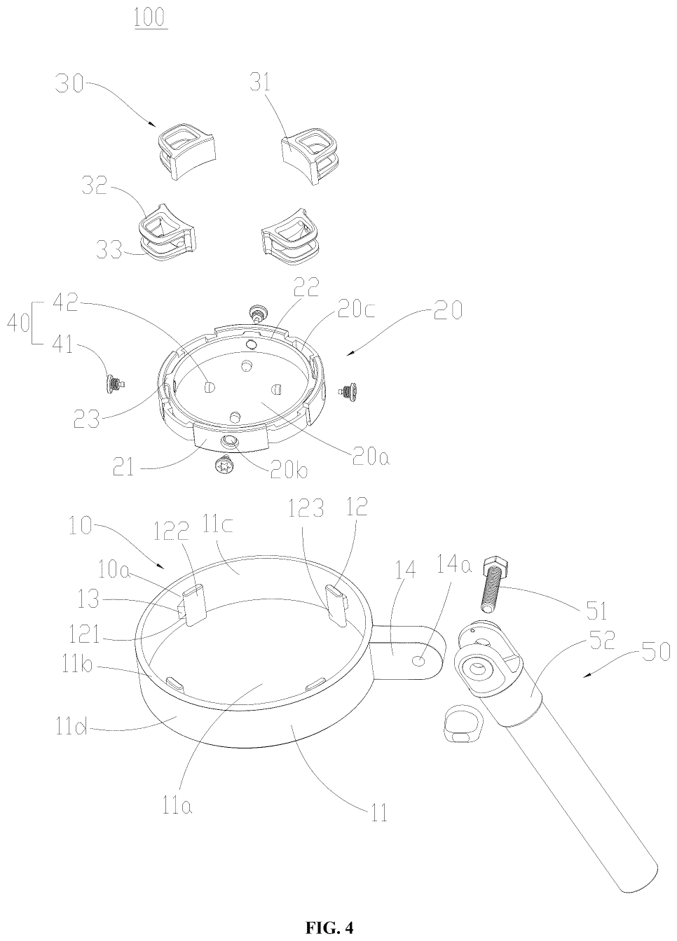

Referring to FIG. 1 and FIG. 2, the present disclosure provides a microphone stand 100 for mounting and fixing a microphone 200. FIG. 3 is a space diagram of a microphone stand 100 when in use provided by the embodiment of the present disclosure. The microphone stand 100 is mounted on an external structure or device, so that a microphone 200 is supported and fixed, and hands of a user can be free to do other things or actions when the microphone is used.

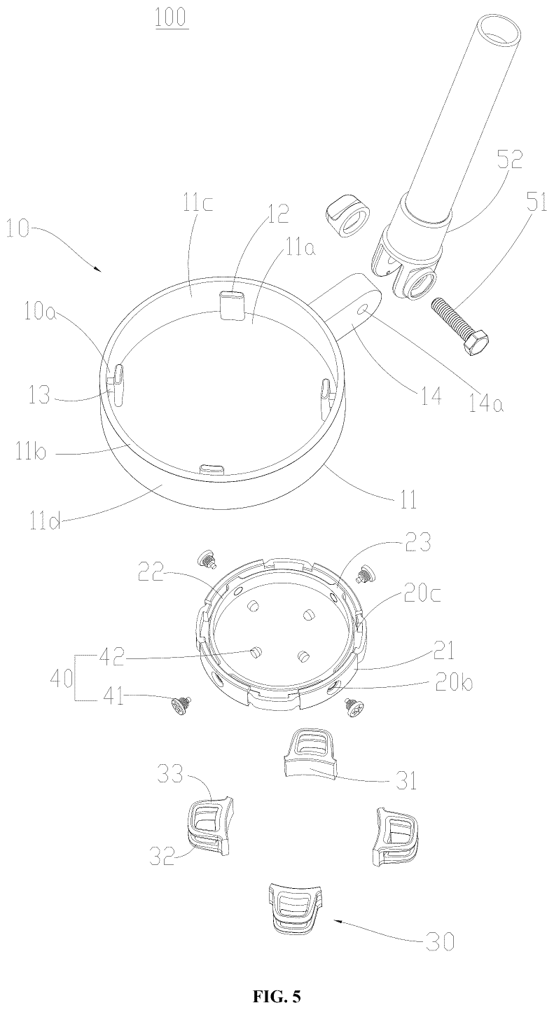

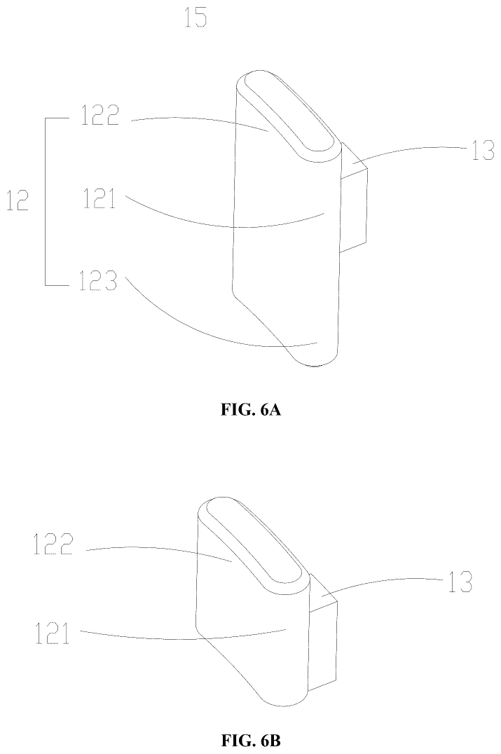

Referring to FIG. 4 and FIG. 5, the microphone stand 100 includes an outer stand 10, an inner stand 20 and a lantern ring assembly 30, wherein the outer stand 10 includes a stand main body 11, and the stand main body 11 is provided with a mounting space 11a. The inner stand 20 is arranged in the mounting space 11a and connected with the stand main body 11, and the inner stand 20 is provided with an accommodating space 20a for accommodating the microphone 200. The lantern ring assembly 30 is connected to the inner stand 20 and the outer stand 10, and the lantern ring assembly 30 is of elasticity.

Compared with the prior art, according to the microphone stand 100 provided by the present disclosure, the inner stand 20 and the outer stand 10 are connected through the elastic lantern ring assembly 30, so that the microphone stand 100 is connected stably, and a certain elastic space can also be formed between the inner stand 20 and the outer stand 10. After the microphone 200 is installed, the microphone 200 can be supported stably, so that the shaking frequency of the microphone 200 is reduced. When sound waves sent out by a sound source are received by the microphone 200, the sound waves can act on each component of the microphone 200 and also can act on the microphone stand 100, so that the microphone 200 and the microphone stand 100 produce unnecessary mechanical vibration to result in increase of ground noise of the microphone 200. The inner stand 20 and the outer stand 10 are connected through the elastic lantern ring assembly 30, so that the influence of mechanical vibration on the sound receiving aspect of the microphone 200 can be reduced to achieve a cushioning effect. Wherein, the ground noise refers to noise generated by the system or equipment without signal input. At the same time, the microphone stand 100 provided by the present disclosure can also avoid large shaking of the microphone 200, so that the effect of protecting the microphone 200 is achieved to prevent the damage of the internal structure.

Specifically, in the embodiment, both the stand main body 11 and the inner stand 20 are of annular structures. The stand main body 11 is provided with two end faces 11b arranged oppositely, and an inner surface 11c and an outer surface 11d which are connected to the two end faces 11b. The stand main body 11 is enclosed to form a mounting space 11a. The inner surface 11c is located in the mounting space 11a. The inner stand 20 is arranged in the mounting space 11a and connected with the inner surface 11c of the outer stand 10.

The outer stand 10 also includes a connecting structure 15 arranged on the inner surface 11c, and the lantern ring assembly 30 sleeves the connecting structure 15. The connecting structure 15 is arranged on the inner surface 11c of the outer stand 10. Through sleeve connection of the lantern ring assembly 30, the connection of the inner stand 20 and the outer stand 10 is facilitated to realize rapid installation and disassembly, and the operation is simple, so that the production assembly efficiency is improved.

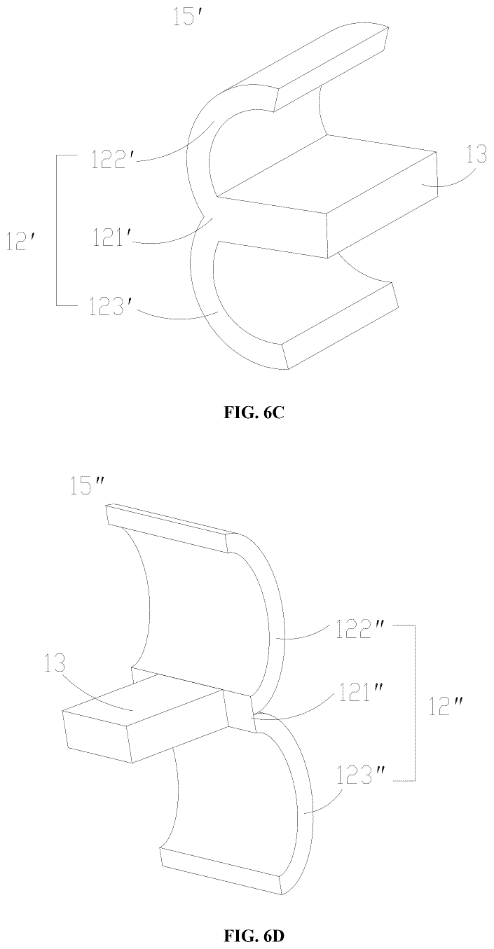

Further, referring to 6A, FIG. 6A is a schematic diagram of a connecting structure 15 of a microphone stand 100 provided by the embodiment of the present disclosure. The connecting structure 15 includes a connecting piece 12 and a connecting block 13. The connecting piece 12 includes a connecting part 121, and a first fixed part 122 and a second fixed part 123 which are connected with the connecting part 121. The first fixed part 122 and the second fixed part 123 are respectively arranged at both ends of the connecting part 121. Specifically, in the embodiment, the connecting piece 12 is of an approximately cuboid structure. The connecting block 13 is connected to the connecting part 121 and the inner surface 11c of the outer stand 10. The lantern ring assembly 30 sleeves the first fixed part 122 and the second fixed part 123. Specifically, mounting gaps 10a are formed between the first fixed part 122 and the inner surface 11c of the stand main body 11 and between the second fixed part 123 and the inner surface 11c of the stand main body 11. When the lantern ring assembly 30 sleeves the first fixed part 122 and the second fixed part 123, the portion of the lantern ring assembly 30 is located in the mounting gap 10a. The lantern ring assembly 30 sleeves the first fixed part 122 and the second fixed part 123, so that the installation and disassembly between the lantern ring assembly 30 and the first fixed part 122 are more convenient, and the operation is simple. The connecting block 13 is connected to the connecting part 121 and the outer stand 10, and the connection is more stable, so that a certain gap is formed between the connecting piece 12 and the inner surface 11c of the outer stand 10, and the sleeving of the lantern ring assembly 30 is facilitated.

Certainly, in other embodiments, the connecting piece 12 can also be of structures in other shapes, and only one of the first fixed part 122 and the second fixed part 123 can be reserved as long as the lantern ring assembly 30 can sleeve the connecting piece 12.

Referring to FIG. 6B, in a deformable embodiment, the connecting piece 12 includes a connecting part 121, a first fixed 122 connected with the connecting part 121, and the lantern ring assembly 30 sleeves the first fixed part 122.

Referring to FIG. 6C, in another deformable embodiment, the shape of the first fixed 122′ and the second fixed part 123′ are semicircular structures.

Referring to FIG. 6D, in yet another deformable embodiment, the shapes of the first fixed part 122″ and the second fixed 123″ are semi-elliptical structures.

Referring to FIG. 6E, in yet another deformable embodiment, the shapes of the first fixed part 122′″ and the second fixed part 123′″ are hook-like structures.

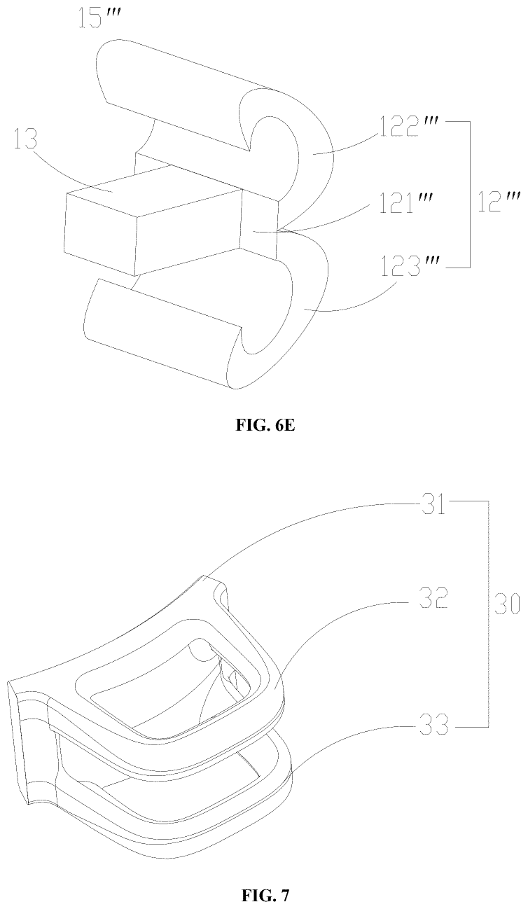

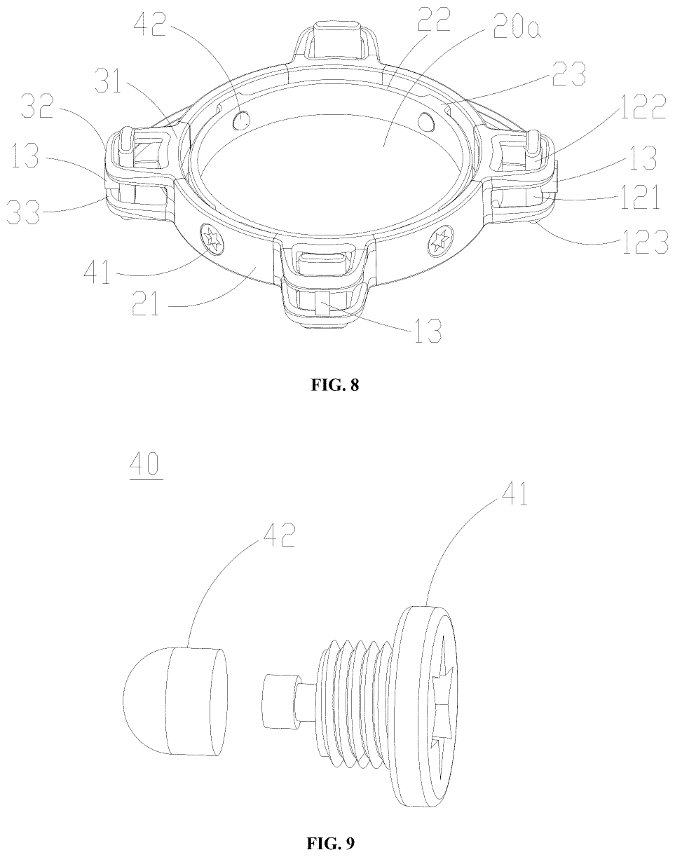

Specifically, referring to FIG. 7, the lantern ring assembly 30 includes a main body part 31, and a first lantern ring 32 and a second lantern ring 33 which are connected with the main body part 31. The first lantern ring 32 and the second lantern ring 31 are located on the same side of the main body part 31. In the embodiment, a certain gap is formed between the first lantern ring 32 and the second lantern ring 33. The gap can facilitate the first lantern ring 32 and the second lantern ring 33 to sleeve the first fixed part 122 and the second fixed part 123 respectively. Referring to FIG. 8, FIG. 8 illustrates a schematic diagram of a cooperative relationship of the lantern ring assembly 30 and a connecting structure 15. The first lantern ring 32 sleeves the first fixed part 122. The second lantern ring 33 sleeves the second fixed part 123. The main body part 31 is connected with the inner stand 20. When the lantern ring assembly 30 sleeves the connecting structure 15, the connecting block 13 is located in the gap between the first lantern ring 32 and the second lantern ring 33, and is connected to the inner surface 11c of the outer stand 10. The first lantern ring 32 and the second lantern ring 33 respectively sleeve the first fixed part 122 and the second fixed part 123, so that the connection can be more stable, and the assembly and production are facilitated. In other embodiments, the first lantern ring 32 also can sleeve the second fixed part 123, and the second lantern ring 33 also can be arranged at the first fixed part 122. Specific limitations are not given in the present disclosure.

In the embodiment, the first lantern ring 32 and the second lantern ring 33 are both of annular structures. In other embodiments, the first lantern ring 32 and the second lantern ring 33 can also be in other shapes. For example, one end is connected to the inner stand 20, and one end connected with the first fixed part 122 and the second fixed part 123 can be of an annular structure, and can be hooked or sleeved with the first fixed part 122 and the second fixed part 123, so that rapid installation and disassembly of the first fixed part 122 and the second fixed part 123 are finally realized. Specific limitations are not given in the present disclosure.

In the embodiment, the lantern ring assembly 30 and the inner stand 20 are integrally formed, specifically by injection molding. Specifically, the inner stand 20 is made of rigid plastics, and the lantern ring assembly 30 is made of elastic materials such as rubber or silica gel. By adopting the integral molding process, the connection between the lantern ring assembly 30 and the inner stand 20 can be more stable. The lantern ring assembly 30 and the inner stand 20 are shaped into a whole in an integral molding mode, the installation is quick, and the operation is simple. Moreover, by adopting the integral molding process, the connection between the lantern ring assembly 30 and the inner stand 20 is more stable, so that the service life is longer. In addition, in the traditional connection mode of a lanyard, in order to reduce the operation difficulty of the user, the microphone and the stand are connected through the lanyard before packaging, and then the packaging, transportation and sale require a large packaging space, so that the cost is increased. And professionals are required to connect the lanyard, so that the cost is further increased. However, the lantern ring assembly 30 and the inner stand 20 are integrally formed in the embodiment of the present disclosure, and direct operation and installation can be realized by the user, so that the overall packaging and transportation cost is reduced.

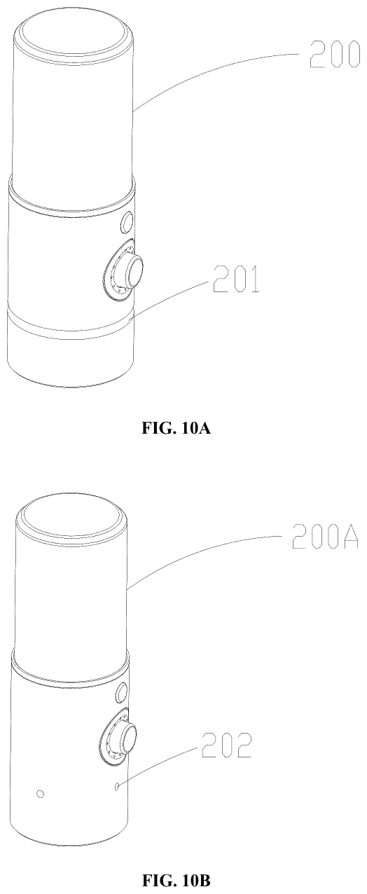

Further, referring to FIG. 9, the microphone stand 100 also includes a locking assembly 40 configured to be adjustable relative to the inner stand 20. One end of the locking assembly 40 is inserted into the inner stand 20 from the outside and extends to the accommodating space 20a to abut against the microphone 200. The locking assembly 40 is arranged to abut against the microphone 200, so that the microphone 200 can be better fixed. And the tightness of the microphone 200 mounted on the microphone stand can be adjusted, so that the installation and disassembly of the microphone 200 are more convenient.

Specifically, referring to FIG. 4 and FIG. 5, a mounting hole 20b which penetrates through the inner stand 20 and communicates with the accommodating space 20a is formed in the inner stand 20. The locking assembly 40 includes a plurality of fixing pieces 41. The fixing piece 41 penetrates through the mounting hole 20b and is configured to be movable along the axial direction inside the mounting hole 20b. The fixing piece 41 is arranged to move axially inside the mounting hole 20b, so that the microphone 200 is locked or loosened, the structure is simple, and the cost is low.

In the embodiment, the axis of the mounting hole 20b is vertical to the outer surface and the inner surface of the inner stand 20. The mounting hole 20b is internally provided with a nut. The fixing piece 41 is provided with an external thread. The fixing piece 41 is in screw joint with the nut. Specifically, the nut is fixedly arranged inside the mounting hole 20b.

In other embodiments, the mounting hole 20b can be internally provided with an internal thread, the nut is provided with an external thread, and the nut is in screw joint with the mounting hole 20b to realize connection. Certainly, the connection of the nut and the mounting hole 20b can also be realized in bonding, clamping, welding or other modes. Specific limitations are not given in the present disclosure.

In other embodiments, the axis of the mounting hole 20b is vertical to the outer surface and the inner surface of the inner stand 20. The mounting hole 20b is internally provided with an internal thread. The fixing piece 41 is provided with an external thread. The fixing piece 41 is directly in screw joint with the mounting hole 20b. The fixing piece 41 is fixed inside the mounting hole 20b through screw connection, and is movable in the mounting hole 20b along the axial direction of the mounting hole 20b. One end of the fixing piece 41 abuts against the microphone 200. The fixing piece 41 can abut against the microphone 200 and also can get away from the microphone 20 by moving axially inside the mounting hole 20b, so that the microphone 200 can be fixed or loosened. The connection between the fixing piece 41 and the microphone 200 and the movement of the fixing piece 41 are realized through screw connection, the structure is simple and practical, and the stability is high.

In order to avoid the microphone 200 from being scratched, the locking assembly 40 also includes a cushion pad 42 for abutting against the microphone 200, and the cushion pad 42 is arranged at one end, located in the accommodating space 20a, of the fixing piece 41. The cushion pad 42 is of elasticity, and the cushion pad 42 is configured to be deformable. Specifically, the raw materials of the cushion pad 42 include silica gel. The cushion pad 42 is arranged, so that the fixing piece 41 can be avoided from scratching the microphone 200 to play a protective role. The cushion pad 42 can also play a cushioning role, the acting force and noise of mechanical vibration are absorbed, and shaking is avoided to cause damage to the internal components of the microphone 200, so that the performance of the microphone 200 is ensured. By adopting the elastic cushion pad 42 with deformability, the shaking of the microphone 200 caused by shaking or vibration can be avoided, and scratching of the microphone 200 or damage to the internal parts of the microphone 200 are avoided.

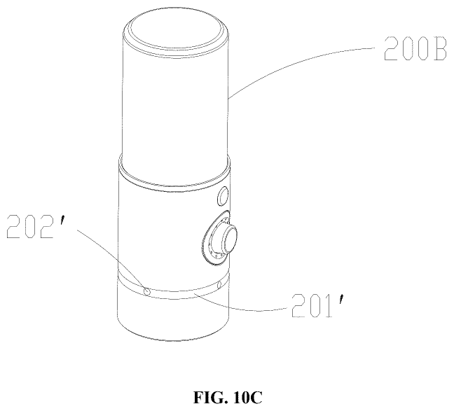

Referring to FIG. 10A, FIG. 10A is a schematic diagram of a microphone provided by the embodiment of the present disclosure. In the embodiment, a groove 201 is formed in the microphone 200 corresponding to the position of the cushion pad 42. The cushion pad 42 abuts against the groove 201, so that the microphone 200 can be fixed more stably. Specifically, the groove 201 is annularly arranged on the outer periphery of the microphone 200. In other embodiments, the groove 201 can be a discontinuous groove, and can be arranged corresponding to the cushion pad 42. In order to further improve the fixation stability, the cushion pad 42 is of a hemispherical structure. The hemispherical cushion pad 42 can better abut against the groove 201 of the microphone 200 internally. Therefore, when the fixing piece 41 gets close to the microphone 200, the hemispherical cushion pas 42 is deformed, and the cushion pad 42 abuts against the groove 201, so that the microphone 200 is firmly fixed. When the fixing piece 41 gets away from the microphone 200, the hemispherical cushion pad 42 is deformed, and the cushion pad 42 gets away from the groove 201, and the microphone 200 can be released by loosening the microphone 200, but the cushion pad 42 does not suddenly get away from the groove 201, so that the microphone 200 is avoided from falling and breaking. The hemispherical structure design can better abut against the microphone 200 and connect the fixing piece 41, so that the microphone 200 is protected. At the same time, the cushion pad 42 abuts against the groove 201 of the microphone 200 internally. When the microphone 200 rotates, the cooperation of the cushion pad 42 and the groove 201 can limit the rotating track of the microphone 200, so that the microphone 200 can rotate along the circumferential direction only but cannot move axially. The cushion pad 42 can play a cushioning role, and can avoid from causing damage to the microphone 200 when the microphone 200 rotates. The cushion pad 42 can also be recovered to an initial state after the rotation of the microphone 200 is complete, so that the microphone 200 continues to remain stationary.

In the embodiment, the maximum outer diameter of the cushion pad 42 is larger than the maximum width of a notch of the groove 201, so that the cushion pad 42 can be partially located inside the groove 201 and partially located outside the groove 201. Therefore, the cushion pad 42 partially abuts against a notch edge of the groove 201, so that sufficient and tight abutting of the cushion pad 42 and the groove 201 is ensured, relative movement of the cushion pad 42 and the groove 201 is avoided, the mechanical collision between the cushion pad 42 and the microphone 200 is avoided, and the ground noise of the microphone 200 is further reduced. In the embodiment, when the user needs to rotate the microphone 200, the user only needs to overcome the elastic force of the cushion pad 42, so that the cushion pad 42 deforms, that is, the circumferential rotation of the microphone 200 relative to the cushion pad 42 can be realized.

Referring to FIG. 10B, in a deformable embodiment, a clamping hole 202 is formed in the microphone 200A corresponding to position of the cushion pad 42. The cushion pad 42 abuts against the clamping hole 202, so that the fixation of the microphone 200A can be more stable. The cushion pad 42 is matched with the shape of the clamping hole 202. Specifically, the cushion pad 42 is of a hemispherical structure. The clamping hole 202 is a hemispherical slot. The maximum diameter of the cushion pad 42 is larger than the opening diameter of the clamping hole 202, so that the cushion pad 42 can partially enter into the clamping hole 202 and is partially located outside the clamping hole 202. Therefore, the cushion pad 42 abuts against the clamping hole 202, so that the relative movement of the cushion pad 42 and the clamping hole 202 is avoided, the mechanical collision between the cushion pad 42 and the microphone 200A is avoided, and the ground noise of the microphone 200A is further reduced. In the embodiment, when the user needs to rotate the microphone 200A, the user only needs to overcome the elastic force of the cushion pad 42, so that the cushion pad 42 deforms and moves out from the clamping hole 202. And then, in the rotating process of the microphone 200A, the cushion pad 42 abuts against the microphone 200A. After the microphone 200A rotates at a certain angle, the cushion pad 42 abuts against another clamping hole 202, and the cushion pad 42 partially enters into the clamping hole 202 to realize location, so that the microphone 200A is fixed again.

Referring to FIG. 10C, in another deformable embodiment, a groove 201′ and a clamping hole 202′ are formed in the microphone 200B corresponding to the position of the cushion pad 42, wherein the clamping hole 202′ is arranged inside the groove 201′, and the groove 201′ is annularly arranged on the outer periphery of the microphone 200B. In the embodiment, the cushion pad 42 is of a hemispherical structure. The clamping hole 202′ is a hemispherical slot. The maximum diameter of the cushion pad 42 is larger than the opening diameter of the clamping hole 202′, so that the cushion pad 42 can partially enter into the clamping hole 202′ and is partially located outside the clamping hole 202. Therefore, the cushion pad 42 abuts against the clamping hole 202′, so that the relative movement of the cushion pad 42 and the clamping hole 202′ is avoided, the mechanical collision between the cushion pad 42 and the microphone 200B is avoided, and the ground noise of the microphone 200B is further reduced. In the embodiment, the maximum outer diameter of the cushion pad 42 is also larger than the maximum width of a notch of the groove 201′, so that the cushion pad 42 is partially located inside the groove 201 and partially located outside the groove 201. Therefore, the cushion pad 42 partially abuts against a notch edge of the groove 201, so that when the cushion pad 42 moves inside the groove 201′, the cushion pad 42 partially abuts against the notch edge and slot bottom of the groove 201′, the cushion pad 42 also can be avoided from colliding with the microphone 200B, and the ground noise of the microphone 200B is reduced. In the embodiment, when the user needs to rotate the microphone 200B, the user only needs to overcome the elastic force of the cushion pad 42, so that the cushion pad 42 deforms and moves out from the clamping hole 202′. And then, in the rotating process of the microphone 200B, the cushion pad 42 abuts against the microphone 200B. Specifically, the microphone 200B slides inside the groove 201′, so that the microphone 200B rotates along the circumferential direction, but the axial movement of the microphone 200B is avoided. After the microphone 200B rotates at a certain angle, the cushion pad 42 abuts against another clamping hole 202′, and the cushion pad 42 partially enters into the clamping hole 202′ to realize location, so that the microphone 200B is fixed again.

In order to further improve the damping effect of the microphone stand 100, continuing to refer to FIG. 4 and FIG. 5, the inner stand 20 includes a first stand 21 and a second stand 22 connected with the first stand 21. The first stand 21 is arranged between the second stand 22 and the outer stand 10. The first stand 21 is connected with the outer stand 10. The second stand 22 is enclosed to form the accommodating space 20a. Specifically, both the first stand 21 and the second stand 22 are of annular structures, and the first stand 21 and the second stand 22 are connected through a connecting rack 23. A gap 20c is formed between the first stand 21 and the second stand 22. The first stand 21 and the second stand 22 are respectively connected to the outer stand 10 and the microphone 200, so that the connection stability can be improved, and the influence of shaking or vibration on the microphone 200 can be reduced. The gap 20c is arranged. When the inner stand 20 is mounted inside the outer stand 10, the first stand 21 is connected with the outer stand 10 through the lantern ring assembly 30, and an acting force can be produced to the first stand 21 under the elastic force effect of the lantern ring assembly 30, so that certain deformation of the first stand 21 occurs. And the gap 20a is formed between the first stand 21 and the second stand 22, so that deformation compensation can be provided when the deformation of the first stand 21 occurs, so that the influence of the deformation of the first stand 21 on the second stand 22 is avoided, the situation that the inner stand 20 is fractured is prevented, the influence on the microphone 200 can also be reduced, and the influence caused by vibration is reduced.

In order to improve the stability of the connection between the inner stand 20 and the outer stand 10, the number of the lantern ring assemblies 30 is four, and the four lantern ring assemblies 30 are uniformly and annularly distributed on the outer surface of the inner stand 20. In order to improve the strength and stability of the inner stand 20, in the embodiment, the mounting hole 20b is formed in the connecting rack 23. Specifically, the mounting hole 20b penetrates the connecting rack 23. The number of connecting racks 23 is four, and the four connecting racks are uniformly distributed between the first stand 21 and the second stand 22, and each connecting stand 23 is located between every two lantern ring assemblies 30. The numbers of the fixing pieces 41 and the cushion pads 42 are four, and the fixing pieces 41 and the cushion pads 42 are in one-to-one correspondence with the mounting hole 20b. Every two fixing pieces 41 and every two cushion pads 42 are arranged oppositely. The microphone 200 can be symmetrically distributed around the microphone 200 when the microphone 200 is fixed, so that the force on the microphone 200 can be balanced when the microphone 200 is fixed, and the stability of the microphone 200 is ensured.

In other embodiments, the number of connecting racks 23 may be one or two or other numbers, and the number of mounting holes 20b, the fixing pieces 41 and the cushion pads 42 may be one or two or other numbers. The numbers are not specifically limited in the present disclosure as long as basic functions can be realized.

In order to facilitate to use and adjust the microphone 200 at a proper angle, the microphone stand 100 also stands a mounting rack 50, and the mounting rack 50 is configured to 10 be rotatably connected with the outer stand 10. The outer stand 10 can rotate relative to the mounting rack 50 by arranging the mounting rack 50, and the angle is convenient for the user to adjust, so that the microphone 200 is convenient for the user to use. The mounting rack 50 may be mounted on a cantilever or other external devices.

Specifically, the outer stand 10 also includes a rotating part 14 connected with the stand main body 11. An axle hole 14a is formed in the rotating part 14. The mounting rack 50 includes a rotating shaft 51 penetrating through the axle hole 14a and a connecting rod 52. One end of the connecting rod 52 is connected with the rotating shaft 51. The other end of the connecting rod 52 can be mounted on a cantilever or other external devices. The connecting rod 52 may be of a columnar structure, a cylindrical structure, or other structures, and is not specifically limited in the present disclosure.

In the embodiment, the outer stand 10, the inner stand 20 and the microphone 200 are all independent, detachable and replaceable accessories or products. Through the lantern ring assembly 30, the lantern ring assembly 30 can be separated from the connecting piece 12 of the outer stand 10 with the elasticity of the lantern ring assembly 30, so that the outer stand 10 and the inner stand 20 can be detachably mounted and separated. The microphone 200 can be detachably mounted and separated from the inner stand 20 by rotating the fixing piece 41. Specifically, the fixing piece 41 gets away from the microphone 200 by rotating the fixing piece 41, and then the microphone 200 moves along the axial direction of the inner stand 20, namely the microphone 200 is separated or mounted to enter the inner stand 20. Through such design, the microphone 200 can be used and mounted more conveniently and quickly. Moreover, when one of the outer stand 10, the inner stand 20 and the microphone 200 breaks down or is damaged, the outer stand 10, the inner stand 20 or the microphone 200 can be disassembled and replaced, so that the use cost of the user is reduced.

The various technical features in the foregoing embodiments may be randomly combined. For concise description, not all possible combinations of the various technical features in the above embodiments are described. However, provided that combinations of these technical features do not conflict with each other, the combinations of the various technical features are considered as falling within the scope of this specification. The foregoing embodiments merely express several implementations of the present disclosure. The descriptions thereof are relatively specific and detailed, but are not understood as limitations on the scope of the present disclosure. A person of ordinary skill in the art can also make several transformations and improvements without departing from the idea of this application. These transformations and improvements fall within the protection scope of this application. Therefore, the protection scope of the patent of this application shall be subject to the appended claims.

What is claimed is:

1. A microphone stand, comprising:
an outer stand, comprising a stand main body, the stand main body being provided with a mounting space;
an inner stand, arranged in the mounting space and connected with the stand main body, and the inner stand being provided with an accommodating space for accommodating a microphone; and
an elastic lantern ring assembly, connected between the inner stand and the outer stand.

2. The microphone stand according to claim 1, wherein the stand main body is provided with two end faces arranged oppositely, and an inner surface and an outer surface which are connected to the two end faces, the outer stand also comprises a connecting structure arranged on the inner surface, and the lantern ring assembly sleeves the connecting structure.

3. The microphone stand according to claim 2, wherein the connecting structure comprises a connecting piece, the connecting piece comprises a connecting part and a first fixed part connected with the connecting part; the connecting part is connected to the inner surface of the outer stand; and the lantern ring assembly sleeves the first fixed part.

4. The microphone stand according to claim 3, wherein the connecting structure also comprises a connecting block, the connecting block is connected to the connecting part and the inner surface of the outer stand.

5. The microphone stand according to claim 3, wherein the connecting piece also comprises a second fixed part connected with the connecting part, and the first fixed part and the second fixed part are respectively arranged at both ends of the connecting part; and the lantern ring assembly sleeves the first fixed part and the second fixed part.

6. The microphone stand according to claim 5, wherein the lantern ring assembly comprises a main body part, and a first lantern ring and a second lantern ring which are connected with the main body part, the first lantern ring sleeves the first fixed part, the second lantern ring sleeves the second fixed part, and the main body part is connected with the inner stand.

7. The microphone stand according to claim 1, wherein the lantern ring assembly and the inner stand are integrally formed.

8. The microphone stand according to claim 1, wherein the microphone stand also comprises a locking assembly configured to be adjustable relative to the inner stand, the locking assembly penetrates penetrate through the inner stand, and the locking assembly is used for abutting against one end of the microphone to extend to the accommodating space.

9. The microphone stand according to claim 8, wherein a mounting hole which penetrates through the inner stand and communicates with the accommodating space is formed in the inner stand; and the locking assembly comprises a fixing piece, the fixing piece penetrates through the mounting hole and is configured to be movable along the axial direction inside the mounting hole.

10. The microphone stand according to claim 9, wherein the mounting hole and the fixed part are provided with matched screw threads, so that the fixing piece is in threaded connection to the mounting hole.

11. The microphone stand according to claim 9, wherein the locking assembly also comprises a cushion pad for abutting against the microphone, and the cushion pad is arranged at one end, located in the accommodating space, of the fixing piece.

12. The microphone stand according to claim 11, wherein the cushion pad is of elasticity, and the cushion pad is configured to be deformable.

13. The microphone stand according to claim 11, wherein the cushion pad is made of silica gel, and the cushion pad is of a hemispherical structure.

14. The microphone stand according to claim 1, wherein the inner stand comprises a first stand and a second stand connected with the first stand, the first stand is arranged between the second stand and the outer stand, the first stand is connected with the outer stand, and the second stand is enclosed to form the accommodating space.

15. The microphone stand according to claim 14, wherein a gap is formed between the first stand and the second stand, a connecting rack is arranged between the first stand and the second stand, and the first stand and the second stand are connected through the connecting rack.

16. The microphone stand according to claim 1, wherein the microphone stand also comprises a mounting rack, and the mounting rack is configured to be rotatably connected with the outer stand.

17. The microphone stand according to claim 16, wherein the outer stand also comprises a rotating part connected with the stand main body, an axle hole is formed in the rotating part, the mounting rack comprises a rotating shaft penetrating through the axle hole and a connecting rod, and one end of the connecting rod is connected with the rotating shaft.

18. A microphone assembly, comprising a microphone and a microphone stand, wherein a groove or a clamping hole is formed in the microphone, or a groove and a clamping hole are formed in the microphone;
the microphone stand comprises:
an outer stand, comprising a stand main body, the stand main body being provided with a mounting space;
an inner stand, arranged in the mounting space and connected with the stand main body, and the inner stand being provided with an accommodating space for accommodating a microphone;
a lantern ring assembly, connected to the inner stand and the outer stand, the lantern ring assembly being of elasticity; and
a locking assembly, configured to be movable relative to the inner stand, the locking assembly penetrating through the inner stand, one end of the locking assembly extending to the accommodating space and being configured to abut against the groove or the clamping hole.

19. The microphone assembly according to claim 18, wherein when a groove and a clamping hole are formed in the microphone, the microphone is surrounded by the groove annularly, the number of the clamping holes is two or more than two, and the clamping holes are formed in the groove at intervals.

20. The microphone assembly according to claim 19, wherein the locking assembly comprises a fixing piece penetrating through the inner stand to abut against the microphone and a cushion pad for abutting against the microphone, the maximum diameter of the cushion pad is larger than the notch diameter of the groove, or the maximum diameter of the cushion pad is larger than the maximum pore diameter of the clamping hole.
